(19) United States
(12) Patent Application Publication
(10) Pub. No.: US 2009/0223078 A1
(43) Pub. Date: Sep. 10, 2009

(54) Stored grain cooling system

(76) Inventor: Randall Glenn Penner, Grassy Lake (CA)

Correspondence Address: Benjamin I. Edlavitch, PO Box 220661, Chicago, IL, 60622-0661, US

(21) Appl. No.: 12/074,981

(22) Filed: Mar. 7, 2008

(51) Int. Cl. F26B 25/06; E04H 7/22

(52) U.S. Cl. 34/219; 454/174

(57) ABSTRACT

An improved and cost effective stored grain cooling system that comprises at least one device that draws air attached to an outside area of a bin and also comprises a perforated pipe that faces in the direction of the device that draws air.

The perforated pipe leads to an outlet that eventually leads to the device that draws air, which allows for heat produced by stored grain to effectively cool. The perforated pipe is suspended in the bin and tightly fits into the outlet leading to the device that draws air. The pipe is suspended by a system of rope-like and chain-like elements that are attached to the pipe and extend outwards and attach to respective areas of the bin.

### BACKGROUND

Grain storing and cooling bins have been around for many years. Usually, grain bins are made up of a concrete base, a sidewall forming a cylindrical housing, and a roof. In the housing or the roof of the grain bin there are often outlets that allow for hot air to escape from the grain bin. Usually mounted over the outlets or mounted within proximity to the outlets is a ventilation system, fan, or turbine. These common devices for circulating air are a common part of grain bins and are useful in assisting the cooling and drying of grain stored in a bin.

Historically, devices that circulate air were positioned on the outside of the sidewall of the bin. While such a mounting is satisfactory, it often leads to uneven airflow. Several modern embodiments of storing and cooling bins, mount the air circulating devices on the roof of the bin. Mounting a air circulating device on the roof takes advantage of the physical nature of hot air traveling upwards.

In embodiments of grain bins, such as the embodiment disclosed in U.S. Pat. No. 4,305,490, the air circulating device is positioned on the roof of the grain bin and the circulation of air is assisted by the device and a complex system of air vents as described in the patent.

Needed in the industry of grain storage, is a stored grain cooling system that makes use of a simpler system for keeping stored grain cool and dry.

### SUMMARY

A stored grain cooling system that comprises a device that draws air out of a grain storage bin. The system comprises perforated pipe that leads to an outlet of a bin. The perforated pipe draws warm air out of grain stored in a bin, which allows for hot air to escape the bin and the grain to effectively cool.

In addition, the perforated pipe is suspended in the bin and a telescoping part of the pipe tightly fits into an outlet of a bin, which leads to a device that draws air. The perforated pipe is suspended by a system of chain-like elements that are attached to the pipe and extend outwards and attach to respective areas of a bin.

### BRIEF DESCRIPTION OF THE DRAWINGS

Below is a description of example embodiments of a grain stored grain cooling system, in conjunction with appended drawings, wherein like reference numerals refer to like elements in figures, and wherein:

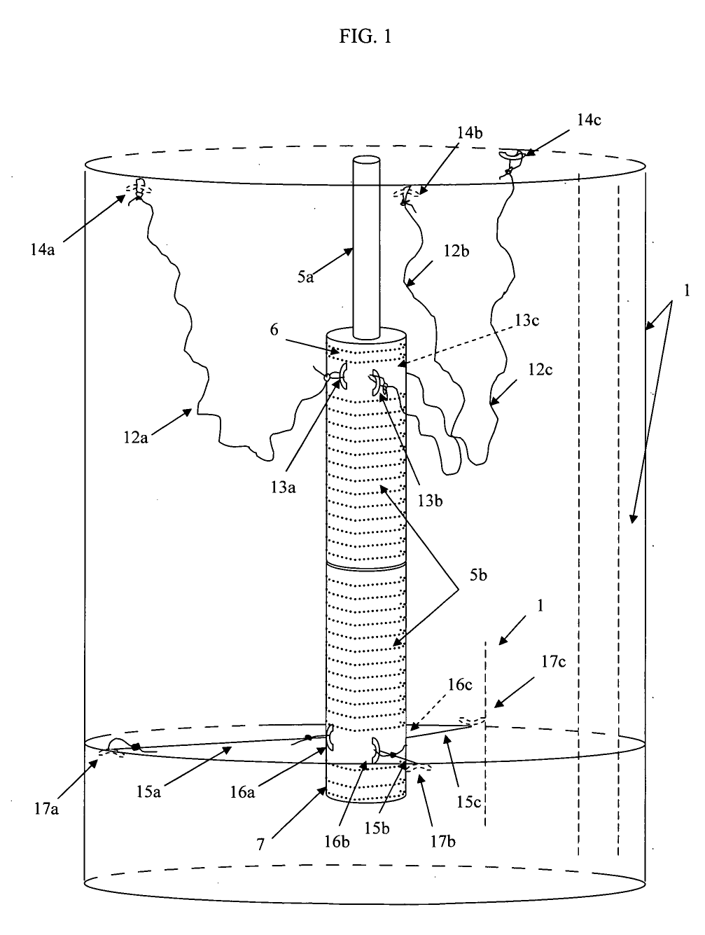

FIG. one (labeled “FIG. 1” in the drawings) is an illustration of a preferred embodiment of the system from the inside of a bin, which shows a perforated pipe of the system, telescoping part of the pipe, and the suspension system of the system for positioning the pipe;

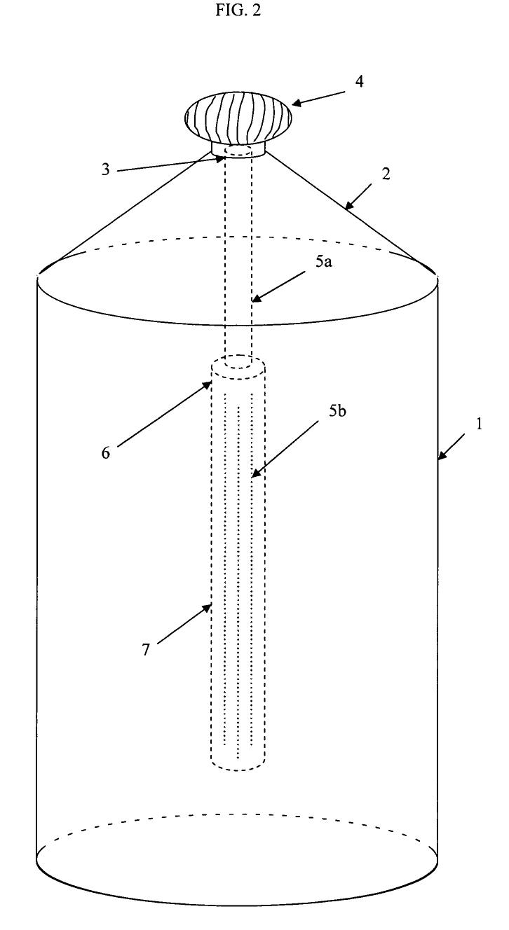

FIG. two (labeled “FIG. 2” in the drawings) is an illustration of a preferred embodiment of the system from the outside of a bin, which shows a device that draws air of the system extending from the bin; and

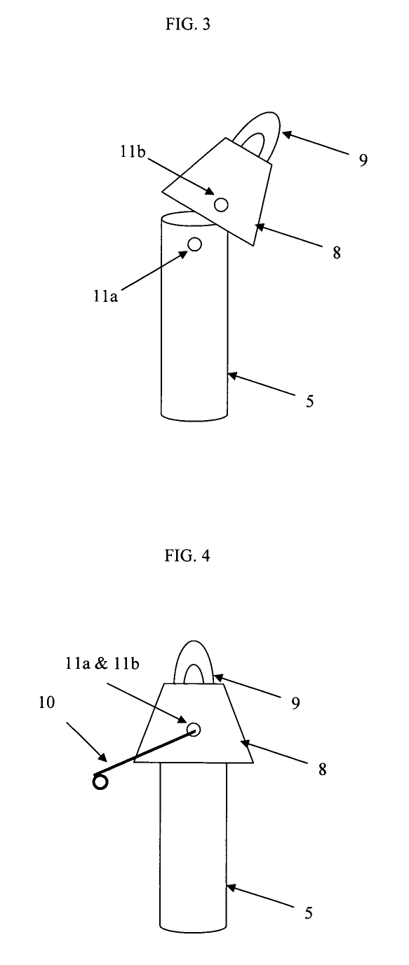

FIGS. three and four (labeled “FIG. 3” & “FIG. 4” in the drawings) are illustrations of a preferred embodiment of the system, which demonstrate a cap and handle mechanism that is employed by the telescoping part of the perforated pipe.

### DETAILED DESCRIPTION

The present specification explains preferred embodiments of a stored grain cooling system. The present detailed description does not limit the system and the system may embody various forms. Furthermore, FIGS. one through four illustrate a preferred embodiment of the system and the figures are merely devices for assisting the explanation of the present detailed description and do not limit the scope of the system.

As illustrated by FIGS. one and two, in general, a bin that employs the stored grain cooling system comprises at least one sidewall 1; a top 2; at least one outlet 3. The stored grain cooling system comprises at least one device that draws air 4 that attaches to an outside area of a bin and covers the outlet 3 of a bin. Furthermore the system comprises at least one perforated pipe 5b, comprising a front-end 6 and a back-end 7, which suspends in a bin, and a upper telescoping part 5a that tightly fits into the outlet 3 of a bin and is removable from the outlet 3.

In preferred embodiments of the stored grain cooling system, the device that draws air 4 is a turbine (see FIG. two).

In preferred embodiments of the stored grain cooling system, the device that draws air comprises: at least one small hole; an outside area that comprises at least one small hole; and a pin that inserts into the hole, which secures the device that draws air to an outside area of a grain storage bin.

In preferred embodiments of the stored grain cooling system, the telescoping part comprises a handle. It is also preferred that the handle attaches to the telescoping part on the front-end of the part. This allows the telescoping part to be pulled out of grain once the bin has been filled with grain.

As shown in FIGS. three and four, in other preferred embodiments of the stored grain cooling system, the telescoping part 5a comprises a removable cap 8; and the cap 8 comprises a handle 9. By capping the telescoping part 5a, grain does not fill the perforated pipe 5b. Furthermore, having the handle 9 on the top or on the front-end of the part 5a, the perforated pipe 5b becomes easier to grab out of grain stored in a bin.

In preferred embodiments of the stored grain cooling system, the cap 8 may be attached to the telescoping part 5a by a pin 10 and at least one hole 11a on the cap 8 and at least one hole 11b on the telescoping part 5a. In other words, the cap 8 and front-end of the telescoping part 5a may each comprise at least one small hole 11a & 11b and a pin that inserts into the small holes 11a & 11b, which secures the cap 8 to the telescoping part 5a. In other embodiments of the system, the cap secures to the perforated pipe in various manners known to those skilled in the art.

In embodiments of the system where an outlet resides on a top of a bin, the pipe suspension system of the system comprises at least one chain-like element that comprises a first-end that attaches to the front-end of the perforated pipe and second-end that attaches to an upper-area of a bin.

In preferred embodiments of the stored grain cooling system, the chain-like element, which attaches to the front-end of the perforated pipe and an upper-area of a bin, is a chain.

In preferred embodiments of the stored grain cooling system, the chain-like element attaches to the front-end of the perforated pipe and an upper-area of a bin in various manners know those of skill in the art. Example methods of attachment include: tying the chain-like element around a hoop element that extends from the point of attachment; wrapping the chain-like element through and around a hoop element and clamping the chain-like element; extending the chain-like element through a hole at the point of attachment and knotting or anchoring the chain-like element; welding or adhering the chain-like element to the point of attachment; like manners of attachment; or any combination thereof.

As shown in FIG. one, in preferred embodiments of the stored grain cooling system, there are three chain-like elements 12a, 12b, & 12c and the three chain-like elements each respectively attach to three separate points 13a, 13b, & 13c (the third point 13c is not visible in the illustration) on the front-end 6 of the perforated pipe 5b that are approximately equal distance from each other. In this embodiment, the three chain-like elements 12a, 12b, & 12c also respectively attach to three separate points 14a, 14b, & 14c on an upper-area of a bin that are approximately equal distance from each other. In addition, the three chain-like elements 12a, 12b, & 12c have approximately equal lengths when measuring the length of each chain-like element 12a, 12b, or 12c from its two points of attachment.

Moreover, in preferred embodiments of the stored grain cooling system where a top area of a bin comprises an outlet, the pipe suspension system also comprises at least one rope-like element that comprises a first-end that attaches to the back-end of the perforated pipe and a second-end that attaches to an inside surface of a sidewall of a bin.

In preferred embodiments of the stored grain cooling system, the rope-like element, which attaches to the back-end of the perforated pipe and the inside surface of a sidewall of a bin, is a wire, cable, or chain.

In preferred embodiments of the stored grain cooling system, the rope-like element attaches to the back-end of the perforated pipe and an inside surface of a sidewall of a bin in various manners know those of skill in the art. Example methods of attachment include: tying the rope-like element around a hoop element that extends from the point of attachment; wrapping the rope-like element through and around a hoop element and clamping the rope-like element; extending the rope-like element through a hole at the point of attachment and knotting or anchoring the ropelike element; welding or adhering the rope-like element to the point of attachment; like manners of attachment; or any combination thereof.

As shown in FIG. one, in preferred embodiments of the stored grain cooling system, there are three additional rope-like elements 15a, 15b, & 15c and the three rope-like elements 15a, 15b, & 15c each respectively attach to three separate points 16a, 16b, & 16c (the third point 16c is not visible in the illustration) on the back-end 7 of the perforated pipe 5b that are approximately equal distance from each other. In this embodiment, the three rope-like elements 15a, 15b, & 15c also respectively attach to three separate points 17a, 17b, & 17c on an inside surface of a sidewall 1 of a bin that are approximately equal distance from each other. In addition, the three rope-like elements 15a, 15b, & 15c have approximately equal lengths when measuring the length of each rope-like element 15a, 15b, or 15c from its two points of attachment.

1. A stored grain cooling system comprising in combination:
at least one device that draws air that attaches to an outside area of a grain storage bin and covers an outlet of a grain storage bin;
at least one perforated pipe comprising a front-end and a back-end that is able to suspend in a bin, tightly fit into an outlet of a bin, and is removable from an outlet of a bin; and
said perforated pipe comprises an upper telescoping part.

2. Said stored grain cooling system of claim 1, wherein said device that draws air is a turbine.

3. Said stored grain cooling system of claim 1, wherein:
said device that draws air comprises at least one small hole; and
a pin inserts into said small hole of said device that draws air and a small hole of an outside area of a bin, which secures said device that draws air to an outside area of a bin.

4. Said stored grain cooling system of claim 1, wherein said upper telescoping part comprises a handle.

5. Said stored grain cooling system of claim 1, wherein said upper telescoping part comprises a removable cap and said cap comprises a handle.

6. Said stored grain cooling system of claim 5, wherein:
said cap comprises at least one small hole;
said front-end of said upper telescoping part comprises at least one small hole; and
a pin inserts into said small hole of said cap and said small hole of said front-end of said upper telescoping part, which secures said cap to said upper telescoping part.

7. Said stored grain cooling system of claim 1, further comprising at least one chain-like element that comprises a first-end that attaches to said front-end of said perforated pipe and a second-end that attaches to an upper-area of a bin.

8. Said stored grain cooling system of claim 7, wherein said chain-like element is a chain.

9. Said stored grain cooling system of claim 7, wherein said manner of attachment of said chain-like element to said front-end of said perforated pipe and an upper-area of a bin is selected from a group consisting of: tying said chain-like element around a hoop element that extends from said point of attachment; extending said chain-like element through a hole in said point of attachment and knotting said chain-like element; welding said chain-like element to said point of attachment; adhering said chain-like element to said point of attachment; like manners of attachment; and any combination thereof.

10. Said stored grain cooling system of claim 7, wherein:
three said chain-like elements each respectively attach to three separate points on said perforated pipe that are approximately equal distance from each other;
said three chain-like elements each respectively attach to three separate points on an upper-area of a bin that are approximately equal distance from each other; and
said three chain-like elements have approximately equal lengths when measuring from said two points of attached of each said chain-like element.

11. Said stored grain cooling system of claim 1, further comprising at least one rope-like element that comprises a first-end that attaches to said back-end of said perforated pipe and a second-end that attaches to an inside surface of a sidewall of a grain storage bin.

12. Said stored grain cooling system of claim 11, wherein said rope-like element is selected from a group consisting of wires, cables, and chains.

13. Said stored grain cooling system of claim 11, wherein said manner of attachment of said rope-like element to said back-end of said perforated pipe and a inside surface of a sidewall of a grain storage bin is selected from the group consisting of: tying said rope-like element around a hoop element that extends from said point of attachment; extending said rope-like element through a hole in said point of attachment and knotting said ropelike element; welding said rope-like element to said point of attachment; adhering said rope-like element to said point of attachment; like manners of attachment; and any combination thereof.

14. Said stored grain cooling system of claim 11, wherein:
three said rope-like elements each respectively attach to three separate points on said perforated pipe that are approximately equal distance from each other;
said three rope-like elements each respectively attach to three separate points on an inside surface of a sidewall of a grain storage that are approximately equal distance from each other; and
said three rope-like elements have approximately equal lengths when measuring from said two points of attachment of each said rope-like element.
